(19) United States
(12) Patent Application Publication
(10) Pub. No.: US 2015/0056907 A1
(43) Pub. Date: Feb. 26, 2015

(54) Actuator, Particularly For A Heating, Ventilation And/Or Air-Conditioning Installation

(71) Applicant: Valeo Systems Thermique, Le Mesnil Saint Denis (FR)

(72) Inventors: Nathalie Dion, Buc (FR); Didier Loup, Maurepas (FR)

(21) Appl. No.: 14/379,111

(22) PCT Filed: Feb. 1, 2013
(86) PCT No.: PCT/EP2013/052023

§ 371 Date: Aug. 15, 2014

(30) Foreign Application Priority Data
Feb. 16, 2012 (FR) 1251425

(51) Int. Cl. H02K 7/116; B60H 1/34; H02K 5/22; B60H 1/00

(52) U.S. Cl. CPC H02K 7/116; B60H 1/00021; B60H 1/3414; H02K 5/225; B60H 2001/00185; B60H 2001/3471
USPC 454/155; 310/83; 310/71

(57) ABSTRACT

The invention relates to an electric actuator able to drive a component of a heating, ventilation and/or air-conditioning installation of a vehicle. The electric actuator comprises a housing accommodating at least an electric motor driving a drive shaft extending along a first axis, a speed reducer driven by the drive shaft and setting in motion an output stub intended to drive the component. The speed reducer extending along a second axis and the output stub extending along a third axis. The first axis, the second axis and the third axis are coincident, thus forming a main axis of the electric actuator.

The technical field of the present invention is that of heating, ventilation and/or air-conditioning installations for a motor vehicle. More particularly, the invention is specific to an actuator capable of controlling the movement of a component installed inside such a heating, ventilation and/or air-conditioning installation.

A heating, ventilation and/or air-conditioning installation thermally regulates a passenger compartment of the vehicle. The heating, ventilation and/or air-conditioning installation therefore needs to allow an airflow sent into the passenger compartment to be moved around and thermally conditioned, in particular with a view to heating and/or cooling the passenger compartment.

To achieve this, a heating, ventilation and/or air-conditioning installation known in the prior art comprises a heat exchanger that performs a heating function, in particular a radiator, and a heat exchanger that performs a cooling function, in particular an evaporator. The airflow circulating in the heating, ventilation and/or air-conditioning installation is thus channelled towards one and/or the other of the heat exchangers to carry out the desired thermal conditioning.

Moreover, such a heating, ventilation and/or air-conditioning installation supplies the thermally treated airflow to particular regions of the passenger compartment, such as a lower passenger compartment region, known as the “foot region”, a windscreen region and/or an upper passenger compartment region, known as the “ventilation region”, in particular located in the vicinity of the face of the vehicle passenger.

Passage of the airflow through heat exchangers and selective distribution of the treated airflow to the various above-mentioned passenger compartment regions are brought about by the actuation of distribution means, such as flaps, arranged through distribution ducts arranged in the heating, ventilation and/or air-conditioning installation. The distribution means are controlled by actuators, such as mechanical or electric actuators.

Some vehicles benefit from electrical or electronic control of the temperature and distribution of the airflow. Control panels thus have at least one electronic circuit and therefore call for electrical control of the distribution means mounted in the heating, ventilation and/or air-conditioning installation. The distribution means are thus coupled to an electric actuator which translates the electric command received into a movement or positioning of the distribution means in the heating, ventilation and/or air-conditioning installation.

At present, known electric actuators use an electric motor, in particular a stepping motor or a DC motor, which drives a worm screw, a wheel or any other type of gear wheel, to set in rotation a set of gear wheels. A shaft of the distribution means is additionally connected to one of the gear wheels, making it possible to move the distribution means when the electric motor is powered.

In the solution known in the prior art, the electric motor is bulky and complicates fitting of the heating, ventilation and/or air-conditioning installation to the vehicle. One proposal by which to overcome this difficulty is to arrange the electric motor of the actuator along a wall of the heating, ventilation and/or air-conditioning installation. The electric motor arranged in this manner thus has a shaft for driving the set of gear wheels, which shaft extends perpendicularly to an axis of rotation of the distribution means.

Such a solution has several drawbacks. Space constraints around heating, ventilation and/or air-conditioning installations are increasing, and the space that was once available for installing the electric motor along the wall is no longer available, since it is used, for example, for laying cables, pipes, additional components, etc.

Moreover, the perpendicular arrangement of the drive shaft of the electric motor relative to the axis of rotation of the distribution means entails the use of a plurality of gear wheels, further adding to the amount of space occupied.

The aim of the present invention is therefore to remedy the drawbacks described above, principally by organising differently the internal structure of the actuator. The object is thus to produce an actuator that occupies little space and is judiciously arranged to allow the electric motor, a speed reducer and a hub for driving the distribution means to be fitted along axes which are parallel to and coincident with the axis of the distribution means. Such an actuator has space requirements that are compatible with the new constraints on fitting heating, ventilation and/or air-conditioning installations.

The present invention therefore relates to an actuator, in particular an electric actuator, capable of driving a component, such as a distribution means, in particular a flap, of a heating, ventilation and/or air-conditioning installation, comprising a housing accommodating at least one electric motor, which drives a drive shaft extending along a first axis, a speed reducer, driven by the drive shaft and setting in motion an output stub intended to drive the component, the speed reducer extending along a second axis and the output stub extending along a third axis. More particularly, the first axis, the second axis and the third axis are coincident, thus forming a main axis of the actuator.

According to a first feature of the invention, the electric motor, the speed reducer and the output stub are stacked in this order along the main axis.

According to a second feature of the invention, the output stub comprises a hub for driving the component which extends along the third axis.

In a case like this, the drive hub is a continuation of the stack formed by the electric motor, the speed reducer and the output stub.

According to another feature of the invention, the housing is formed by assembling a first half-housing and a second half-housing.

According to another feature of the invention, a means is provided for aligning the electric motor and the speed reducer, which is advantageously in contact with yet separate from the housing.

In a situation like this, the alignment means comprises a base inserted between the electric motor and the speed reducer, comprising a first lateral face and a second lateral face which are arranged so as to ensure alignment of the electric motor and the speed reducer.

According to another feature of the invention, the alignment means comprises at least one protrusion interposed between the two half-housings.

According to the present invention, the electric motor is, for example, a stepping motor or a DC motor.

Advantageously, the speed reducer comprises at least one support on which at least two sun gears rest which drive a ring gear connected to the output stub.

Also advantageously, a printed circuit is installed in the housing in a plane of extension parallel to the main axis of the actuator.

According to one embodiment, the actuator comprises an electrical plug that is rigidly connected to the printed circuit and mechanically connected to the housing.

In this case, the electrical plug comprises at least one electrical terminal that is rigidly connected to the printed circuit. Preferably, the electrical terminal extends in a direction perpendicular to the main axis of the actuator.

According to a variant, the printed circuit is fitted to control actuation of the electric motor.

The invention also covers a heating, ventilation and/or air-conditioning installation comprising at least one component driven by an actuator according to any of the preceding features.

The heating, ventilation and/or air-conditioning installation comprises a wall which defines an internal volume of the heating, ventilation and/or air-conditioning installation with respect to the surrounding area, the component being a flap installed in the internal volume and the actuator being fastenedto the wall in the surrounding area.

A first advantage according to the invention is the option of controlling a flapmounted in the heating, ventilation and/or air-conditioning installation by an actuator of small size compared with the solutions of the prior art. The space freed up by the actuator according to the invention can then be used to incorporate other parts or components.

Another advantage is the ease with which such an actuator is assembled. Indeed, the electric motor and the speed reducer are arranged mechanically in the same unit which is accommodated in the housing, despite being separate therefrom. Reliability of assembly is improved and the steps of positioning and closing the half-housings are thereby facilitated.

The actuator described above is combined with a device for fastening the actuator to the wall of the heating, ventilation and/or air-conditioning installation, comprising one or more of the features listed below:
the fastening device comprises at least one protuberance which starts at the wall and cooperates with an element originating from the housing of the actuator to lock the position of the actuator relative to the wall;
the protuberance is integrally formed with the wall and comprises at its free end a tooth for holding a connecting element of the actuator;
the holding tooth is oriented towards the actuator;
the holding tooth is oriented in the opposite direction to the actuator;
the protuberance has at least one curvilinear sector;
the protuberance has a cavity;
the protuberance originating from the wall is more flexible than the connecting element originating from the housing, or the connecting element originating from the housing is more flexible than the protuberance originating from the wall;
the connecting element of the housing comprises a linking portion, which extends radially to the housing, and a locking portion, which extends in an angular manner around the housing;
the locking portion starts at the linking portion and is separate from the housing;
the locking portion has a finger bar capable of cooperating with the protuberance;
the connecting element comprises another linking portion, which extends radially to the housing, the locking portion being separate from the housing and connected to the linking portions so as to form a shackle;
the wall comprises an opening directly adjacent tothe protuberance, the housing comprising a skirt that seals the opening.

The actuator according to the invention is also combined with an electrical connector to form a unit. Such a connector comprises one or more of the features listed below:
the electrical connector is intended to electrically connect at least one cable to the actuator, capable of driving a component of a heating, ventilation and/or air-conditioning installation of a vehicle, the connector comprising at least a first connection portion, capable of accommodating one end of the cable, and a second connection portion, capable of locking the actuator in a position relative to the heating, ventilation and/or air-conditioning installation;
the second connection portion is separate from the first connection portion, the first connection portion and the second connection portion being mechanically interconnected by a connecting body;
the first connection portion, the connecting body and the second connection portion define a recess, capable of receiving a portion of the actuator and a portion of a wall of the heating, ventilation and/or air-conditioning installation;
the second connection portion has a conical profile, in a cross section passing through the first connection portion and the second connection portion;
the second connection portion is deformable;
the connecting body is flexible;
the first connection portion comprises at least a locking means capable of blocking translation of the electrical connector relative to the actuator and/or to the wall of the heating, ventilation and/or air-conditioning installation.

The heating, ventilation and/or air-conditioning installation according to the present invention comprises at least a cable and/or at least an electrical connector as previously described, in which:
the heating, ventilation and/or air-conditioning installation comprises a wall comprising a connecting appendage which receives the second connection portion of the electrical connector;
the second connection portion seals the connecting appendage in an air-tight manner;
the wall comprises a projection which extends from a plane of extension of the wall and in which the connecting appendage is arranged;
the connecting appendage is defined by a bevelled edge.

Naturally, the various features, variants and embodiments of the present invention can be combined with one another in various combinations as long as they are not mutually incompatible or exclusive.

The present invention will be better understood and other features and advantages will become more apparent upon reading the following detailed description comprising embodiments given for illustrative purposes with reference to the accompanying drawings, presented as non-limiting examples, which may be used to supplement understanding of the present invention and how it is carried out and, where appropriate, contribute to its definition, and in which:

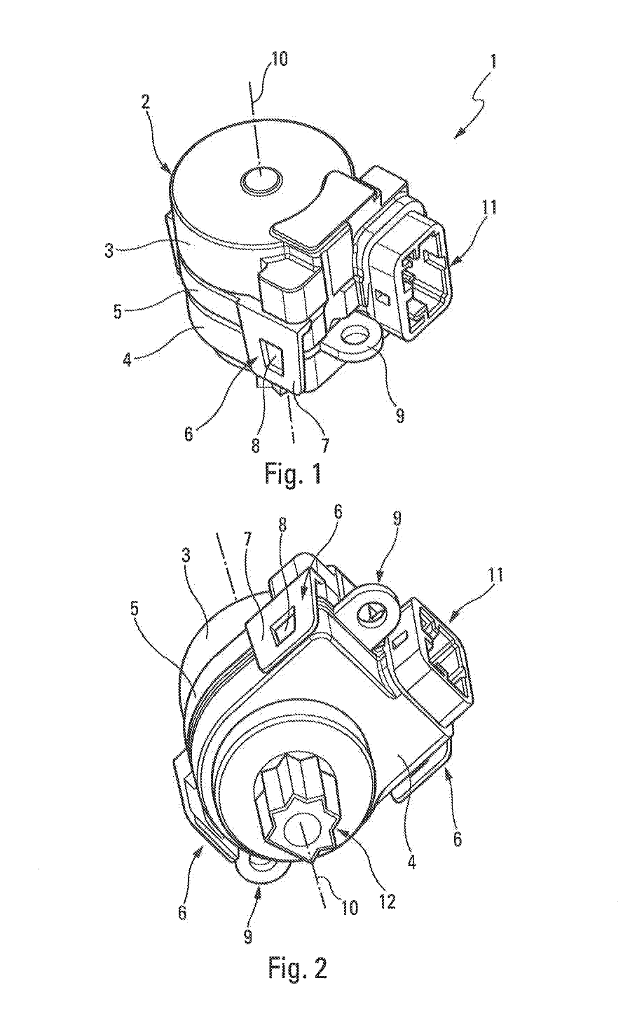

FIG. 1 is a side perspective view of an actuator according to the present invention;

FIG. 2 is a bottom perspective view of the actuator in FIG. 1;

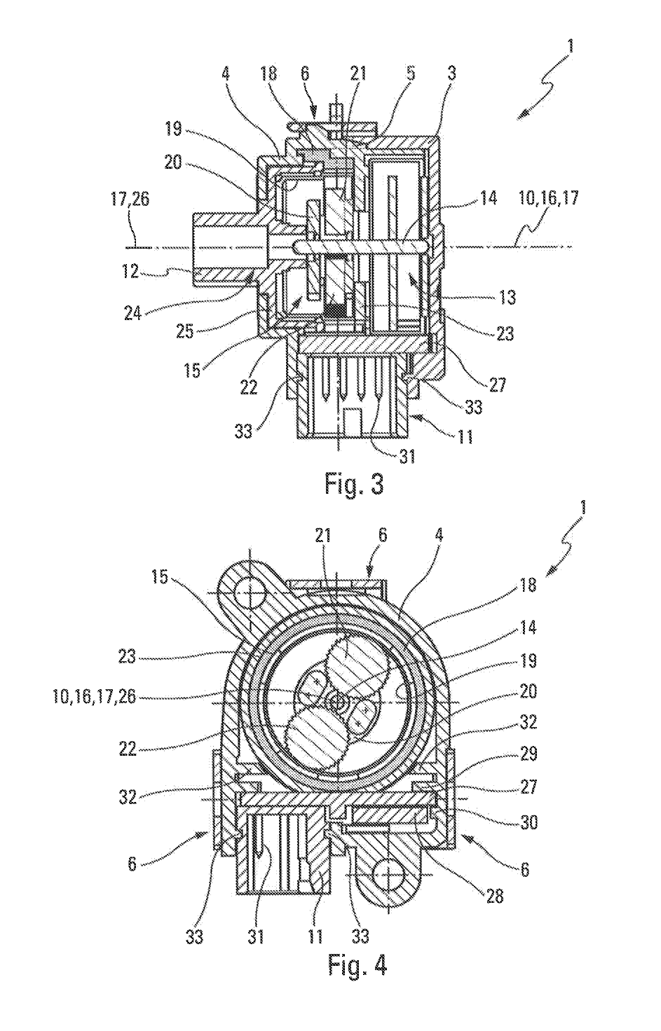

FIG. 3 is a longitudinal section of the actuator in FIG. 1;

FIG. 4 is a cross section of the actuator in FIG. 1;

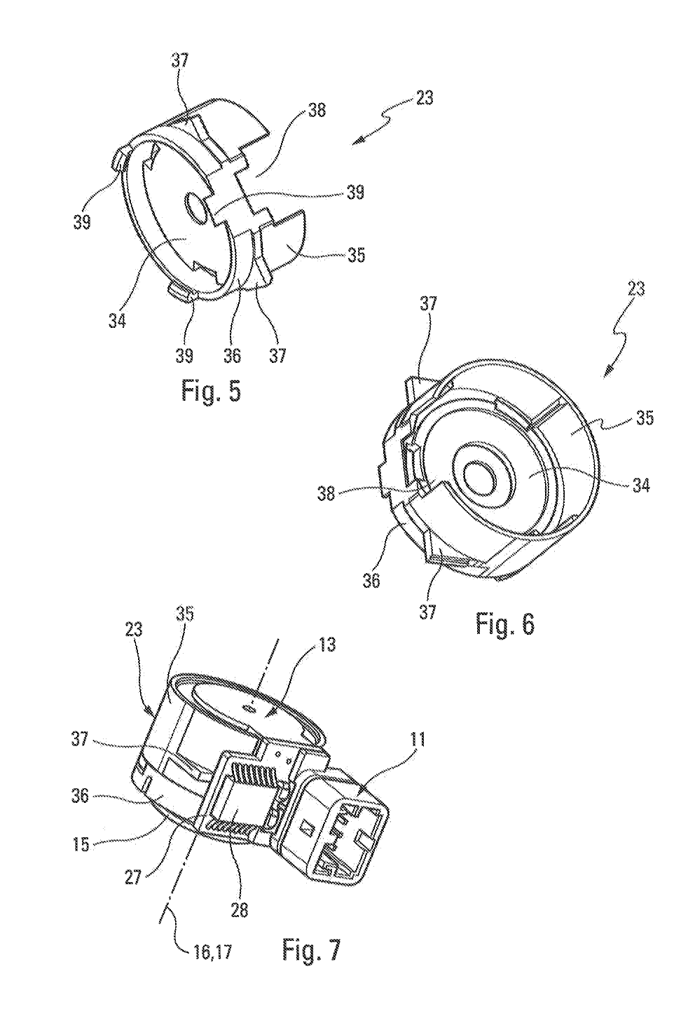

FIG. 5 is a bottom perspective view of the alignment means used in the actuator in FIG. 1;

FIG. 6 is a top perspective view of an alignment means in FIG. 5;

FIG. 7 is a perspective view showing the alignment means in FIGS. 5 and 6 on which an electric motor and a speed reducer are mounted;

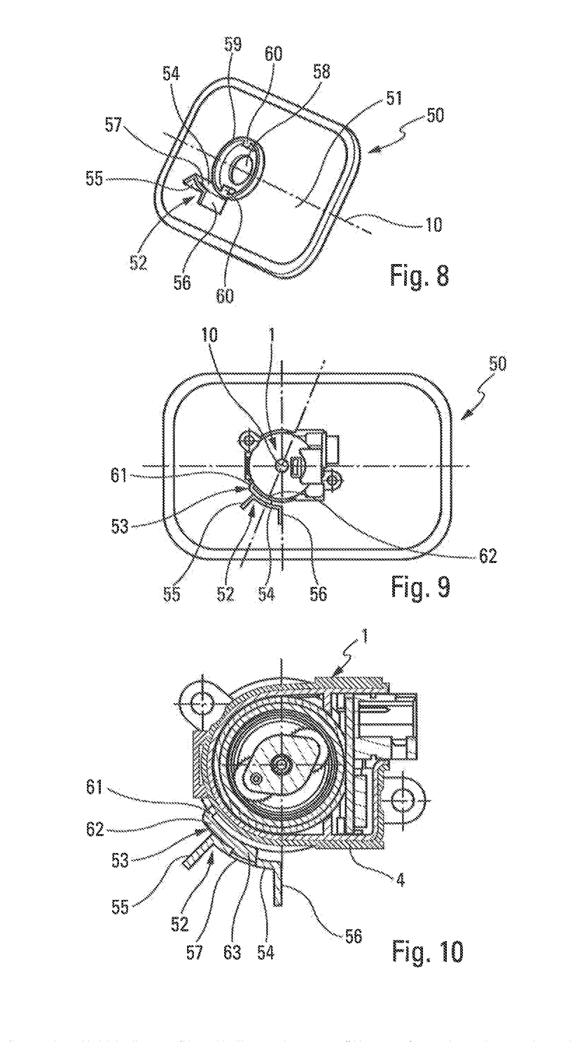

FIG. 8 is a perspective view of a device for fastening an actuator to a wall according to the present invention;

FIG. 9 is a top view of the fastening device in FIG. 8;

FIG. 10 is a cross section of the fastening device and of the actuator which is rigidly connected to the wall of the heating, ventilation and/or air-conditioning installation;

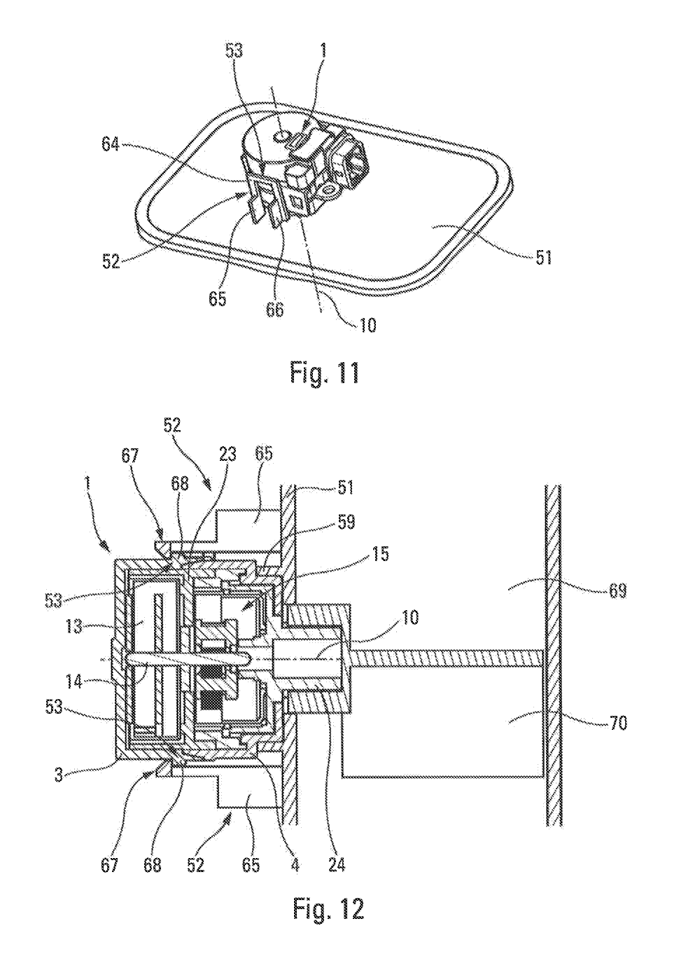

FIG. 11 is a perspective view of a first variant of the device for fastening an actuator to a wall of a heating, ventilation and/or air-conditioning installation;

FIG. 12 is a longitudinal section of the first variant of the device for fastening an actuator to a wall of a heating, ventilation and/or air-conditioning installation;

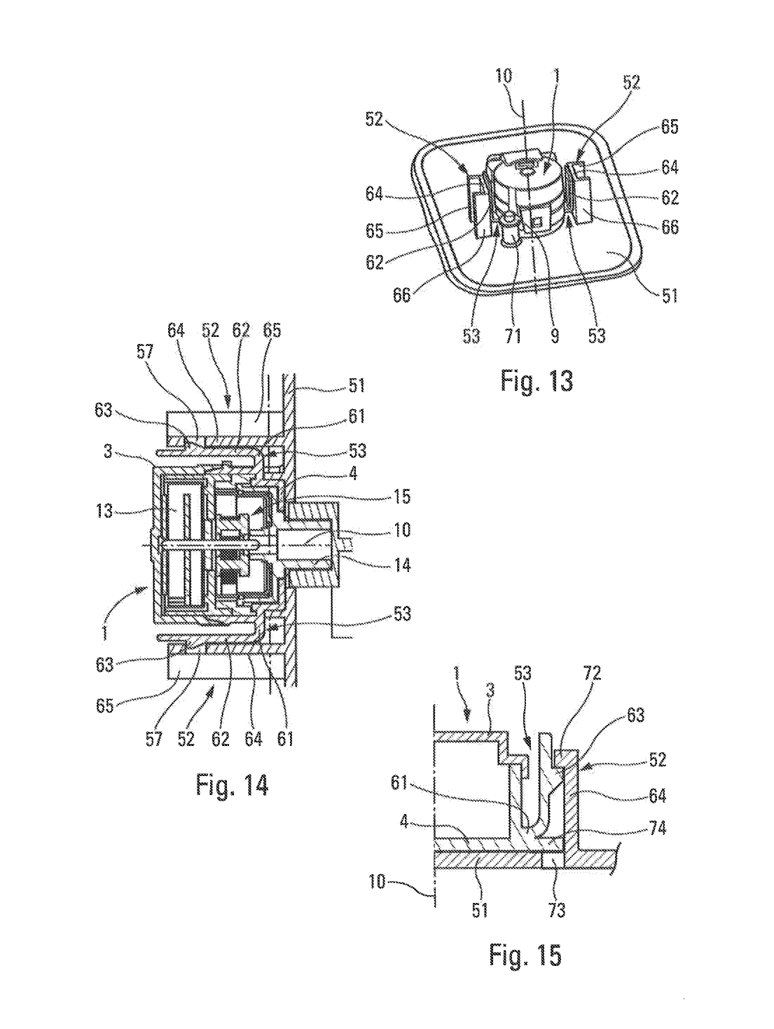

FIG. 13 is a perspective view of a second variant of the device for fastening an actuator to a wall of a heating, ventilation and/or air-conditioning installation;

FIG. 14 is a longitudinal section of the second variant of the device for fastening an actuator to a wall of a heating, ventilation and/or air-conditioning installation;

FIG. 15 is a section of a detail of an alternative to the second variant of the device for fastening an actuator to a wall of a heating, ventilation and/or air-conditioning installation;

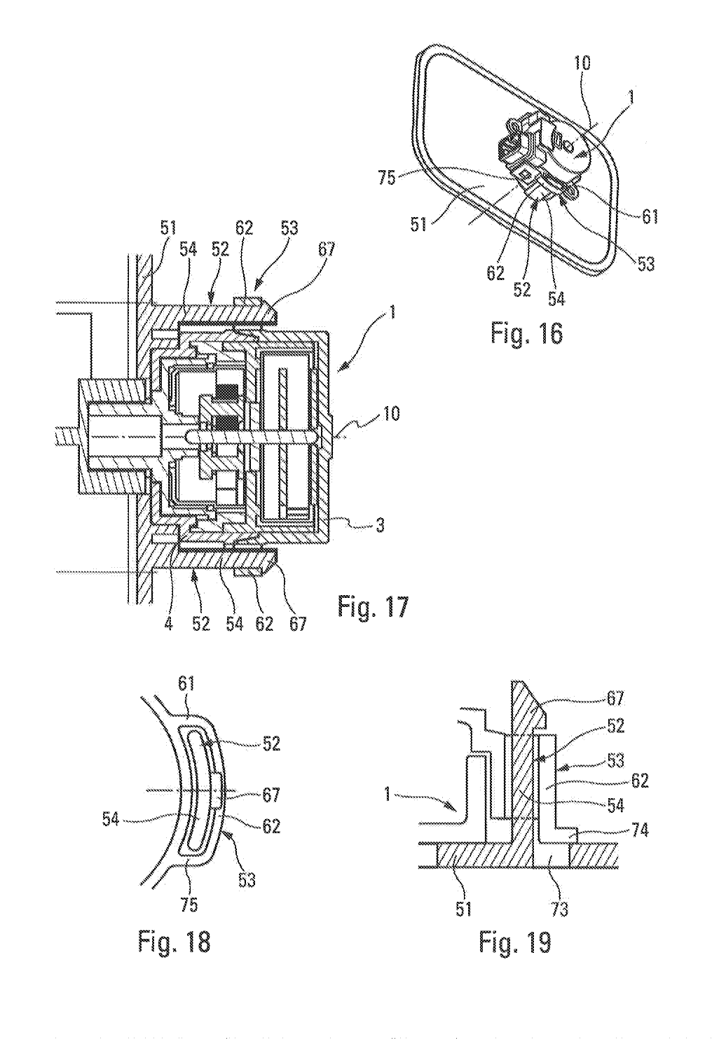

FIG. 16 is a perspective view of a third variant of the device for fastening an actuator to a wall of a heating, ventilation and/or air-conditioning installation;

FIG. 17 is a longitudinal section of the third variant of the device for fastening an actuator to a wall of the heating, ventilation and/or air-conditioning installation;

FIG. 18 is a top view of part of the third variant of the device for fastening an actuator to a wall of a heating, ventilation and/or air-conditioning installation;

FIG. 19 is a cross section of a detail of an alternative to the third variant of the device for fastening an actuator to a wall of a heating, ventilation and/or air-conditioning installation;

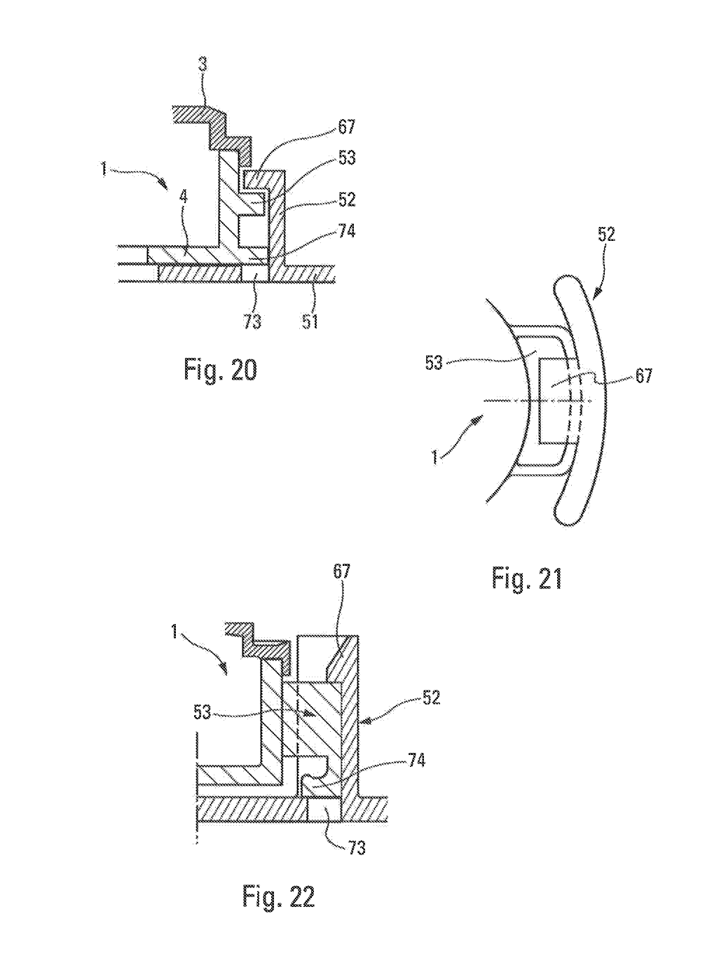

FIG. 20 is a cross section of a detail of a fourth variant of the device for fastening an actuator to a wall of a heating, ventilation and/or air-conditioning installation;

FIG. 21 is a top view of part of the fourth variant of the device for fastening an actuator to a wall of a heating, ventilation and/or air-conditioning installation;

FIG. 22 is a cross section of a detail of a fifth variant of the device for fastening an actuator to a wall of a heating, ventilation and/or air-conditioning installation;

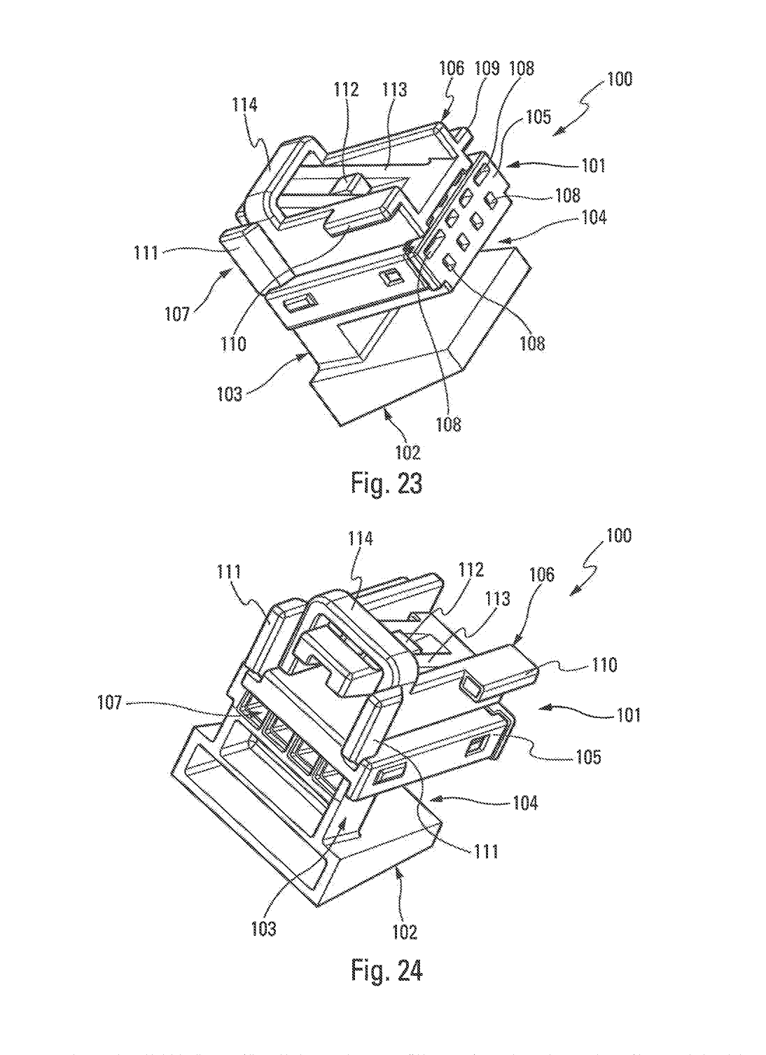

FIG. 23 is a perspective view of a first side of an electrical connector for electrically linking a cable to an actuator according to the present invention;

FIG. 24 is a perspective view of a second side of the electrical connector in FIG. 23;

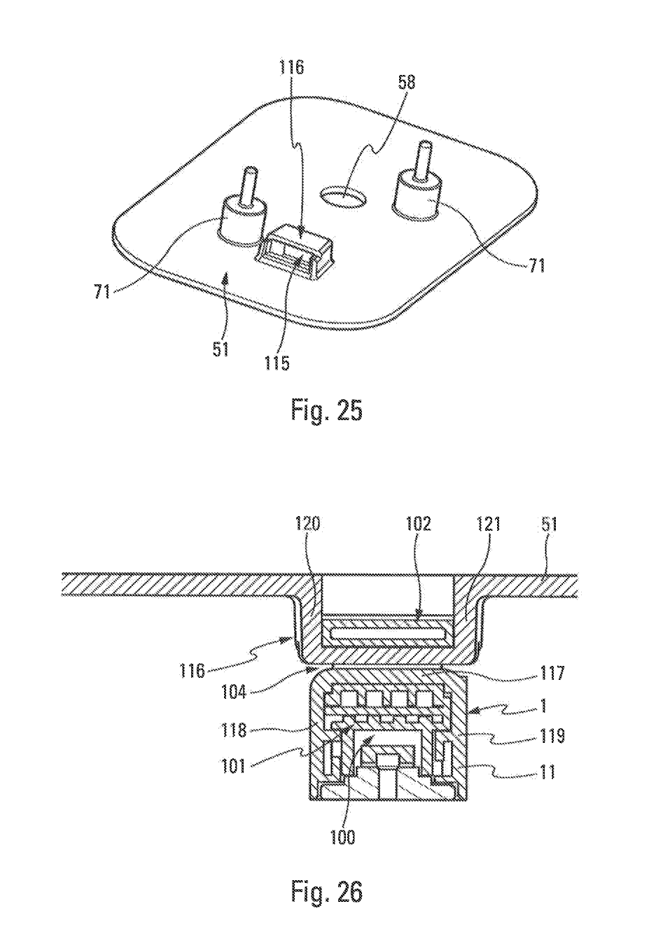

FIG. 25 is a perspective view of a wall of the heating, ventilation and/or air-conditioning installation capable of receiving the electrical connector in FIG. 23;

FIG. 26 is a cross section of an actuator which is rigidly connected to the wall of the heating, ventilation and/or air-conditioning installation by means of the electrical connector according to the present invention;

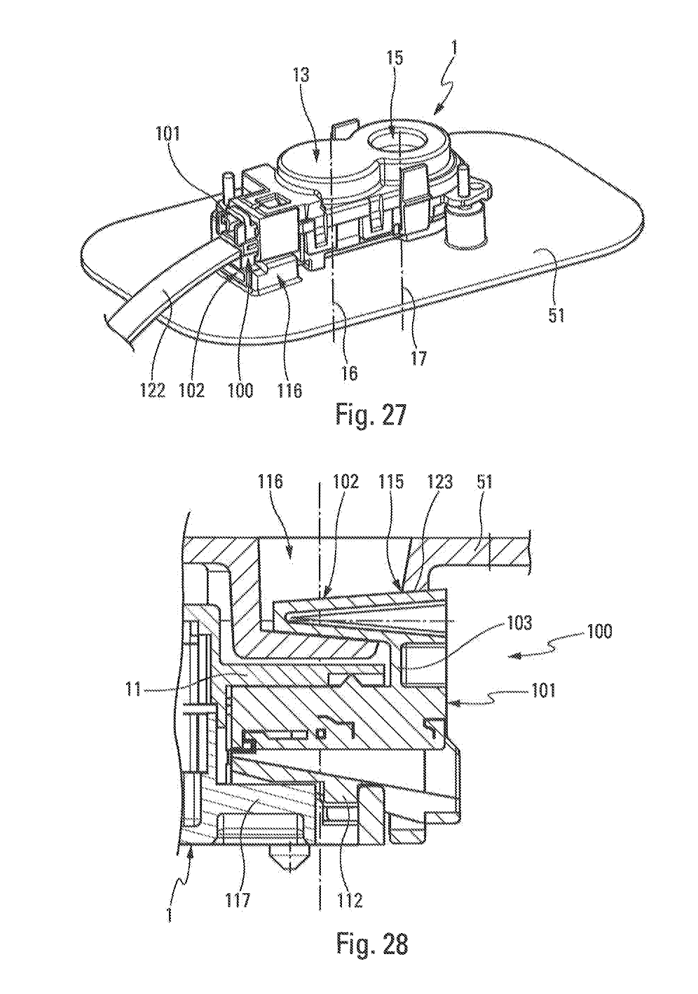

FIG. 27 is a perspective view of an actuator connected to the wall by means of the electrical connector according to the present invention;

FIG. 28 is a longitudinal section of the wall, of the actuator and of the electrical connector according to the present invention.

It should be noted that, in the figures, structural and/or functional elements common to the various embodiments may have the same references. Thus, unless stated otherwise, such elements have identical structural, dimensional and material properties.

FIGS. 1 and 2 show, respectively, side and bottom perspective views of an actuator 1, in particular intended to be mounted on a wall and suitable for controlling in rotation a component accommodated in a heating, ventilation and/or air-conditioning installation. The actuator 1 is, advantageously, an electric actuator 1.

The actuator 1 comprises a housing 2, preferably formed by a first half-housing 3 and a second half-housing 4. The first half-housing 3 and the second half-housing 4 form, respectively, a casing which covers and protects the constituent elements of the actuator 1. The first half-housing 3 and the second half-housing 4 are joined to one another at a mating surface 5 where the first half-housing 3 and the second half-housing 4 are joined, in particular by overlapping. A mechanical connection is produced between the first half-housing 3 and the second half-housing 4 by at least one connecting means 6, in particular a clipping element 6. Preferably, the actuator 1 comprises three clipping elements 6, as is apparent in FIG. 2. Such a clipping means 6 is formed by a tab 7 connected to one of the half-housings 3 or 4, and in which a through-hole or a blind-hole is made. The clipping element 6 also comprises a finger 8 formed on the other half-housing 4 or 3, which is accommodated in the through-hole or blind-hole in the tab 7.

According to the present invention, the actuator 1 advantageously has a substantially circular body. The actuator 1 contains, in particular, an electric motor 13, a speed reducer 15, in particular produced from sun gears, an output stub 24 for driving the component arranged in the heating, ventilation and/or air-conditioning installation. These elements will be described in more detail with reference to FIGS. 3 to 7.

The actuator 1 comprises protrusions, in particular extending from the body containing the electric motor 13, the speed reducer 15 and the output stub 24. The protrusions are, in particular, a centring piece 9, for example formed by an eyelet originating from the second half-housing 4, substantially at the mating surface 5. The centring piece 9 comprises a hole intended to cooperate with a centring pin formed on the wall of the heating, ventilation and/or air-conditioning installation. According to the variant shown in FIGS. 1 and 2, the actuator 1 comprises two centring pieces 9, advantageously arranged in a diametrically opposed manner relative to a main axis 10 of the actuator 1. The main axis 10 corresponds to the axis about which the output stub 24 rotates.

An electrical plug 11 also extends from the body of the actuator 1, advantageously in a radial manner. Such an electrical plug 11 forms an electrical interface between the electric components of the actuator 1 and an electrical connector 100, transmitting control signals and power signals.

According to a variant, the electrical connector 100 is of the conventional type. Alternatively, the electrical connector 100 is suitable for cooperating with the actuator 1 shown specifically in FIGS. 1 and 2. Such an electrical connector 100 is described in particular with reference to FIGS. 23 and 24.

In this embodiment of the actuator 1, the electrical plug 11 comprises a compartment in which the electrical connector 100 is plugged.

As shown in FIG. 2, the actuator 1 comprises a hub 12 for driving the output stub 24. The driving hub 12 is the rotating region located on the exterior of the actuator 1 and from which rotational movement is transmitted to the component of the heating, ventilation and/or air-conditioning installation. In the embodiment shown, the driving hub 12 has an external face which, viewed in cross section, forms a star.

As shown in FIG. 3, the actuator 1 has a drive shaft 14. More specifically, FIG. 3 is a longitudinal section of the actuator 1 in FIG. 1; that is, a section taken in the direction of extension of the drive shaft 14 of the actuator 1; and FIG. 4 is a cross section of the actuator 1 in FIG. 1; that is, a section taken in a direction perpendicular to the direction of extension of the drive shaft 14. The description below therefore refers to these two figures.

The first half-housing 3 and the second half-housing 4 are placed on top of each other at the mating surface 5 and are mechanically interconnected by the clipping element 6. According to the present invention, the first half-housing 3 accommodates the electric motor 13. In particular, the electric motor 13 is traversed longitudinally relative to the drive shaft 14.

The drive shaft 14 is also known as the “intermediate drive shaft” in the sense that it connects in rotation the electric motor 13 and the speed reducer 15, in particular a speed reducer having sun gears. The drive shaft 14 transmits movement from the electric motor 13 to the speed reducer 15.

The drive shaft 14 extends along a first axis 16. The drive shaft 14 passes through the speed reducer 15 from one end to the other, and leads into the output stub 24.

The electric motor 13 is advantageously a stepping motor. It may also be a DC motor.

The speed reducer 15 extends overall along a second axis 17 passing through the centre of the speed reducer 15.

According to the present invention, the speed reducer 15 comprises a fixed ring 18, a ring gear 19 and a support 20. Preferably, the ring gear 19 has a toothed internal surface. In addition, the support 20 allows at least a first sun gear 21 and a second sun gear 22 to be held in position.

According to a preferred embodiment of the speed reducer 15, the ring 18 is fixed in the sense that it is rigidly connected to the housing 2 for rotation therewith, in particular to the second half-housing 4. The rigid connection of the ring 18 and the housing 2 is advantageously obtained through direct connection or via an alignment means 23, which will be presented in detail below.

According to this embodiment, the ring 18 is circular and comprises a shoulder for accommodation thereof in the alignment means 23. It is thereby ensured that the ring 18 is centred relative to other components of the speed reducer 15.

The ring gear 19 has on its internal face a series of teeth which cooperate with teeth formed on the first sun gear 21 and the second sun gear 22. Advantageously, the ring gear 19 comprises a bottom connected in rotation to the output stub 24. The ring gear 19 is deformable by the rotary action of the first sun gear 21 and of the second sun gear 22 and assumes an ovoid shape when the actuator 1 provides driving torque.

The support 20 is a part that is locked in rotation and, advantageously, in translation along the second axis 17. The first sun gear 21 and/or the second sun gear 22 rotate about a sun gear shaft borne by the support 20.

The speed reducer 15 comprises a first sun gear 21 and a second sun gear 22. However, it goes without saying that the invention is not limited to this particular number and also covers speed reducers 15 having a larger number of sun gears. The first sun gear 21 and the second sun gear 22 are each formed by a toothed wheel, otherwise known as a gear wheel, of which the teeth cooperate with the teeth formed on the ring gear 19.

The output stub 24 is a part having a base 25 connected to the drive hub 12. Preferably, the output stub 24 is recessed at its centre and the end of the drive shaft 14 extends into the central, recessed portion of the output stub 24.

The output stub 24 rotates about a third axis 26, which passes through the centre of the drive hub 12.

According to the invention, the first axis 16 of the drive shaft 14 of the electric motor 1, the second axis 17 of the speed reducer 15 and the third axis 26 of the output stub 24 are coincident.

The first axis 16, the second axis 17 and the third axis 26 can thus be considered to form one and the same axis, this axis forming the main axis 10 of the actuator 1. It will be noted that, advantageously, the main axis 10 is also coincident with the axis of the component intended to be driven in rotation by the actuator 1 according to the invention.

According to the present invention, the electric motor 13, the alignment means 23, the speed reducer 15 and the output stub 24 are therefore stacked in this order and along the main axis 10 of the actuator 1.

FIGS. 3 and 4 also show the arrangement of the electrical plug 11, and the presence of a printed circuit 27.

The printed circuit 27 comprises an electrically insulating substrate bearing a plurality of conductor tracks and a plurality of electronic components 28. The printed circuit 27 may also bear the electrical plug 11. Moreover, the printed circuit can form a device for controlling the electric motor 13, by adapting the signals received by the electrical plug 1 to the command mode of the electric motor 13. Alternatively, or additionally, the printed circuit 27 performs the diagnostics of the actuator 1 and/or communicates with a CAN or LIN multiplexed network, in particular via a cable 122 linked to the electrical connector 100. Additionally, the printed circuit 27 can be recentred on the alignment means 23.

The printed circuit 27 is planar and extends in a plane parallel to the main axis 10. In other words, the plane of extension of the printed circuit 27 does not intersect the first axis 16, the second axis 17 or the third axis 26.

The printed circuit 27 is in contact with the first half-housing 3 and, advantageously, with the second half-housing 4. In at least one of the half-housings 3 or 4, and in particular in both, a first rib 29 and a second rib 30 are provided. The space between the first rib 29 and second rib 30 forms a slideway accommodating the printed circuit 27. Such a slideway is an example of a means for rigidly connecting the printed circuit 27 in the actuator 1.

FIG. 4 also shows a device for positioning the unit formed by the alignment means 23, the electric motor 13 and the speed reducer 15. At least one of the half-housings 3 or 4 comprises at least one positioning rib 32 on which the alignment means 23 comes to bear. In this embodiment, the half-housing 3 or 4, comprises two positioning ribs 32. Advantageously, the positioning rib 32 comprises a bevelled end to match theshape, said shape being in particular circular, of the alignment means 23. Such a configuration makes it possible to easily press the unit formed by the alignment means 23, the electric motor 13 and the speed reducer 15 against the, in particular circular, portion of the body of the actuator 1.

The electrical plug 11 bears against the printed circuit 27. The electrical plug 11 comprises at least one electrical terminal 31 which projects from the printed circuit 27, preferably in a direction perpendicular to the main axis 10 of the actuator 1. In the embodiment shown, the electrical plug 11 comprises four electrical terminals 31. Nevertheless, the number of electrical terminals 31 is simply an embodiment.

To prevent the generation of mechanical stress on the printed circuit 27 during insertion or extraction of the electrical connector 100 with respect to the electrical plug 11, at least one of the half-housings 3 or 4 comprises a device for relieving the load on the electrical plug 11. Such a load relief device is, for example, in the form of at least one relief rib 33, formed in the first half-housing 3 and/or in the second half-housing 4. In order to perform the load relief function, the electrical plug 11 has a shape complementary to the relief rib 33, in particular a channel which receives the relief rib 33 during assembly of the actuator 1.

FIGS. 5 and 6 show in detail the alignment means 23 in a bottom perspective view and a top perspective view respectively. In addition, FIG. 7 is a perspective view showing the alignment means 23 in FIGS. 5 and 6 on which the electric motor 13 and the speed reducer 15 are mounted.

The function of the alignment means 23 is to facilitate assembly of the actuator 1 ensuring alignment of the electric motor 13 relative to the speed reducer 15. It is therefore possible to produce a semi-finished intermediate product comprising the alignment means 23, the electric means 13 and the speed reducer 15 in perfect alignment.

The alignment means 23 comprises a base 34, inserted between the electric motor 13 and the speed reducer 15. A first lateral face 35 and a second lateral face 36 extend from the base 34, preferably in a direction perpendicular to the base 34. The first lateral face 35 and the second lateral face 36 are arranged on either side of the base 34 and thus each form a peripheral collar. The base 34 and the first lateral face 35 define a first, advantageously circular, compartment, in which the electric motor 13 is received. Similarly, the base 34 and the second lateral face 36 define a second compartment, in which the speed reducer 15 is received. The electric motor 13 and the speed reducer 15 are thus aligned by a single monolithic part incorporated between the first half-housing 3 and the second half-housing 4 of the actuator 1.

The alignment means 23 and the housing 2 of the actuator 1 are mechanically connected by at least one protrusion 37. The protrusion 37 is interposed between the first half-housing 3 and the second half-housing 4 forming the housing 2. In the example in FIGS. 5 to 7, the alignment means 23 comprises two protrusions 37.

By way of example, the protrusion 37 is a flat region extending at the external periphery of the alignment means 23, in a plane that is parallel and advantageously coincident with the plane of extension of the base 34. In a preferred manner, the plane of extension of the base 34 and the plane of extension of the protrusions 37 are perpendicular to the first axis 16 of the electric motor 13 and to the second axis 17 of the speed reducer 15.

Preferably, the first lateral face 35 comprises a punched portion 38 over a determined angular sector. The punched portion 38 allows for the passage of the electrical connections required to power the electric motor 13, coming from the printed circuit 27.

In addition, the second lateral face 36 is advantageously extended by a plurality of claws 39, for example three claws, the function thereof being to block the fixed ring 18, which can be seen in FIGS. 3 and 4, in longitudinal translation.

The base 34 also comprises a central open passage through whichthe drive shaft 14 of the electric motor 13 passes.

FIG. 7 shows the positioning of the printed circuit 27 equipped with the electrical plug 11 and the electronic components 28. The printed circuit 27 is thus installed at the periphery of the alignment means 23, on the exterior of and along the first lateral face 35 and/or the second lateral face 36.

The actuator 1 described in relation to FIGS. 1 to 7 is, for example, intended for fastening to a wall 51 of a heating, ventilation and/or air-conditioning installation 50. Such fastening can be produced by means of one or more screws, for example.

Alternatively, fastening of the actuator 1 to the wall 51 of the heating, ventilation and/or air-conditioning installation 50 can be achieved by any of the variants of afastening device described in relation to FIGS. 8 to 22, or by the electrical connector 100 described in relation to FIGS. 23 to 28. Advantageously, such fastening of the actuator 1 will be achieved without the use of screws.

The invention also covers the heating, ventilation and/or air-conditioning installation 50 comprising the wall 51 defining an internal volume of the heating, ventilation and/or air-conditioning installation 50 with respect to a surrounding area.

In configuration like this, the component controlled in rotation by the actuator 1 is advantageously a flap installed in the internal volume. In addition, the actuator 1 is advantageously attached to the wall 51 in the surrounding area. In a case like this, it will be understood that the electric motor 13 and the speed reducer 15 extend entirely into the surrounding area. Thus, according to the present invention, the actuator 1 and the component controlled in rotation by the actuator 1 are arranged on either side of the wall 51 of the heating, ventilation and/or air-conditioning installation 50.

FIGS. 8 to 22 shows various embodiments for fastening the actuator 1 to the wall 51 of the heating, ventilation and/or air-conditioning installation 50.

For all these variants, the actuator 1, which is the object of the fastening device, generally comprises the housing 2 accommodating the electric motor 13 which drives, by means of the speed reducer 15, the output stub 24 intended for setting in motion the component, in particular the flap. Alternatively, the present invention also covers the actuators 1 accommodating the electric motor 13 that directly drives the output stub 24 intended to set the component in motion.

More precisely, the actuator 1 comprises the electric motor 13 which drives the drive shaft 14 extending along the first axis 16, the speed reducer 15 which is driven by the drive shaft 14 and sets in motion the output stub 24 intended to drive the component, the speed reducer 15 extending along the second axis 17 and the output stub 24 extending along the third axis 26, wherein the first axis 16, the second axis 17 and the third axis 26 are coincident, and thus form the main axis 10 of the actuator 1.

In a case like this, the actuator 1, which is the object of the fastening device, may comprise one or more of the features presented in detail with reference to FIGS. 1 to 7.

FIGS. 8 to 10 show an embodiment of afastening device between the actuator 1 and a wall 51 of the heating, ventilation and/or air-conditioning installation 50 in a perspective view, a top view and a cross section respectively.

The wall 51 is shown here in part. However, the wall 51 forms, generally speaking, the boundary between an internal volume of the heating, ventilation and/or air-conditioning installation 50, in which an airflow travelswhich has been or is to be treated, and the surrounding area.

The fastening device according to the invention comprises at least two main portions, namely, first, a protuberance 52 starting at the wall 51 and, second, a connecting element 53, originating from the housing 2 of the actuator 1. The function of the fastening device is to block, or in other words lock, the actuator 1 relative to the wall 51 of the heating, ventilation and/or air-conditioning installation 50.

According to the variant shown in FIGS. 8 to 10, the protuberance 52 is integrally formed with the wall 51 when said wall is moulded. Advantageously, the protuberance 52 has a curvilinear sector 54 which extends, in particular, in a direction perpendicular to a plane of extension of the wall 51.

According to the particular embodiment shown, the protuberance 52 also comprises a first reinforcement 55 and a second reinforcement 56 arranged at each end of the curvilinear sector 54. The first reinforcement 55 and the second reinforcement 56 are also integrally formed with the wall 51 and extend radially to the main axis of the actuator 1. Preferably, the first reinforcement 55 and the second reinforcement 56 each form an acute angular sector with the curvilinear sector 54.

According to a variant, the protuberance 52 is considered to be rigid, in the sense that is does not deform when the actuator 1 is joined to the wall 51. Put differently, the connecting element 53 is more deformable, or in other words more flexible, than the protuberance 52.

The protuberance 52 also comprises a cavity 57 made, for example, in the curvilinear sector 54. Such a cavity 57 is in particular blind, although it may also pass through the curvilinear sector 54.

The wall 51 also comprises a passage 58 through which the output stub 24 of the actuator 1 passes, and more particularly the driving hub 12 of the output stub 24.

A ring 59 is arranged at the periphery of the passage 58. The ring 59 is advantageously integrally formed with the wall 51. Moreover, an internal face of the ring 59 bears at least one notch 60, preferably two diametrically opposed notches 60. The ring 59 and the notches 60 may be complementary to the fastening device of the invention, in particular in the sense that they take part in blocking the actuator 1 in translation relative to the wall 51 along the main axis 10.

The fastening device according to the invention also ensures an air-tight seal between the actuator 1 and the wall 51 to prevent the airflow present in the internal volume of the heating, ventilation and/or air-conditioning installation 50 from escaping into the surrounding area.

The connecting element 53 is, advantageously, integrally formed with the housing 2 of the actuator 1. The connecting element 53 is therefore produced at the same time as the housing 2 in the same moulding step. Nevertheless, according to an alternative embodiment, the connecting element 53 can be produced as a part that is attached and fastened to the housing 2 of the actuator 1.

Advantageously, the connecting element 53 is arranged only on the first half-housing 3 and/or the second half-housing 4. According to the example in FIG. 10, the connecting element 53 is formed on the second half-housing 4.

According to this particular embodiment, the connecting element 53 forms a tongue that extends in part radially and in part angularly around the actuator 1.

The connecting element 53 therefore comprises a linking portion 61 that extends radially outwards from the housing 2 of the actuator 1. The connecting element 53 comprises a locking portion 62 that forms an angle, for example equal to 90°, with the linking portion 61.

Preferably, the locking portion 62 follows a curved profile along the housing 2 of the actuator 1. It is in this manner that the locking portion 62 extends angularly around the housing 2 of the actuator 1.

Aside from its connection to the first portion 61, the locking portion 62 is separate from the housing 2 of the actuator 1. Such a configuration allows the connecting element 53 to have greater flexibility than the protuberance 52.

The locking portion 62 comprises a finger bar 63 capable of cooperating with the protuberance 52, and in particular with the cavity 57 in the protuberance 52. In particular, the finger bar 63 is capable of being accommodated in the cavity 57. According to one embodiment, the finger bar 63 is arranged at the free end of the locking portion 62.

Rotation of the actuator 1 about the main axis 10 in the plane of the wall 51 brings about pressurisation of the locking portion 62 bearing against the protuberance 52. Since the locking portion 62 is flexible, it deforms radially towards the main axis 10 of the actuator 1. By continuing the rotation of the actuator 1, the finger bar 63 penetrates into the cavity 57, allowing the locking portion 62 to return to its initial position.

Advantageously, the curvature of the curvilinear sector 54 is substantially identical to the curvature of the locking portion 62 around the actuator 1.

FIG. 10 shows the internal make-up of an embodiment of the actuator 1. In this regard, reference will be made to FIGS. 1 to 7 for the description of the actuator 1.

FIGS. 11 and 12 show a first variant of the fastening device in a perspective view and a longitudinal section respectively. The description that will be given of the first variant of the fastening device is limited to the different elements and reference will be made to the description relating to the fastening device in FIGS. 8 to 10 for like elements.

According to the first variant, the fastening device comprises at least one protuberance 52 originating from the wall 51. Preferably, two protuberances 52 of identical structure are arranged on the wall 51 and are, for example, diametrically opposed on either side of the actuator 1 mounted on the wall 51.

According to the first variant, the protuberance 52 comprises a planar sector 64 of substantially rectangular shape. It is recessed at its centre so as to form a ‘U’ of which each branch starts at the wall 51.

The protuberance 52 comprises a first reinforcement 65 and a second reinforcement 66 in contact with the planar sector 64, in particular in the region of the branches of the ‘U’. Preferably, the first reinforcement 65 and the second reinforcement 66 originate from the wall 51 and are moulded simultaneously with the flat sector 64 and the wall 51. It will be noted that the height of the first reinforcement 65 and of the second reinforcement 66 is less than the height of the flat sector 64, measured in a direction parallel to the main axis 10 of the actuator 1. Such a structure affords the protuberance 52 flexibility in a direction substantially perpendicular to the main axis 10 of the actuator 1. In a configuration like this, the connecting element 53 on which the protuberance 52 comes to bear is less flexible than the protuberance 52. It is therefore understood that the protuberance 52 is deformed when the actuator 1 is mounted on the wall 51 of the heating, ventilation and/or air-conditioning installation 50.

The flexibility of the protuberance 52 is obtained by means of a suitable thickness of the planar sector 64, measured radially relative to the main axis 10 of the actuator 1. The thickness of the planar sector 64 is, for example, between 0.5 and 2 mm, measured in a radial direction relative to the main axis 10 of the actuator 1.

At the free end of the protuberance 52 a holding tooth 67 is formed which cooperates with the connecting element 53 of the housing 2 of the actuator 1. According to this variant, the holding tooth 67 extends radially towards the actuator 1. The holding tooth 67 comprises a flat region that engages on the connecting element 53 of the housing 2 of the actuator 1.

According to this embodiment, the connecting element 53 is formed by a shoulder 68 arranged on the housing 2 of the actuator 1. Such a shoulder 68 may be formed on the first half-housing 3 and/or the second half-housing 4.

However, when the housing 2 of the actuator 1 is such that the second half-housing 4 is in contact with the wall 51 and is comprised between the first half-housing 3 and the wall 51, it is advantageous to arrange the shoulder 68 on the first half-housing 3 so as to fasten the actuator 1 to the wall 51 while securing the mechanical connection between the first half-housing 3 and the second half-housing 4.

FIG. 12 shows a section of the actuator 1 mounted on the wall 51 of the heating, ventilation and/or air-conditioning installation 50. The heating, ventilation and/or air-conditioning installation 50 comprises an air duct 69 through which there flows the airflow which has been or is to be treated, and in which the component 70 controlled in rotation by the actuator 1 is arranged. According to the present invention, the component 70 is arranged through the air duct 69. Such a component 70 is, for example, an air inlet flap, a mixingflap or a distribution flap of the heating, ventilation and/or air-conditioning installation 50.

The actuator 1 contains the electric motor 13 and the drive shaft 14, preferably the speed reducer 15, and the output stub 24, which output stub controls the rotation of the component 70 about the main axis 10 of the actuator 1. Advantageously, the actuator 1 comprises the means 23 for aligning the electric motor 13 and the speed reducer 15.

It will be noted that the wall 51 comprises the ring 59 inside which the housing 2 of the actuator 1, in particular the second half-housing 4, is accommodated.

FIGS. 13 to 15 show a second variant of the fastening device in a perspective view, longitudinal section and a section of a detail. The description that will be given of the second variant of the fastening device is limited to the different elements and reference will be made to the description relating to the fastening device in FIGS. 8 to 12 for like elements.

The wall 51 of the heating, ventilation and/or air-conditioning installation 50 according to the second variant of the fastening device comprises at least one protuberance 52, advantageously two protuberances 52. The protuberance 52 is formed by a planar sector 64, a first reinforcement 65 and a second reinforcement 66, similar to those of the protuberance 52 according to the first variant of the fastening device illustrated in FIGS. 11 and 12.

The first reinforcement 65 and the second reinforcement 66 extend in planes perpendicular to the plane of extension of the flat sector 64. It will be noted that the height of the first reinforcement 65 and of the second reinforcement 66 is equal, or substantially equal, to the height of the planar sector 64, measured in a direction parallel to the main axis 10 of the actuator 1. Such a structure affords the protuberance 52 rigidity, such that it does not deform during mounting of the actuator 1 on the wall 51. Correlatively, the connecting element 53 arranged on the actuator 1 is made to be more flexible than the protuberance 52.

The flat sector 64 of the protuberance 52 comprises a cavity 57 that receives the connecting element 53 originating from the housing 2 of the actuator 1. According to various alternatives, the cavity 57 may be a blind cavity or a through-cavity.

In the embodiment in FIG. 13, the fastening device comprises a centring pin 71, advantageously moulded with the wall 51. In addition, the centring piece 9 is arranged on the housing 2 of the actuator 1 and comprises a hole in which a free end of the centring pin 71 is accommodated.

The connecting element 53 cooperating with the protuberance 52 has a particular structure. The actuator 1 comprises the same number of connecting elements 53 as the number of protuberances 52 on the wall 51. According to the embodiment shown, the actuator 1 comprises two connecting elements 53 in the form of an arm extending from the housing 2 of the actuator 1. As for the preceding variants of the fastening device, the connecting element 53 is interposed between the housing 2 of the actuator 1 and the protuberance 52 provided on the wall 51.

According to the second variant, the connecting element 53 is integrally formed with the second half-housing 4. The connecting element 53 therefore comprises a linking portion 61 that extends radially from the housing 2 of the actuator 1. The connecting element 53 comprises a locking portion 62 that forms an angle, for example equal to 90°, with the linking portion 61.

Preferably, the locking portion 62 extends axially along the actuator 1 in the direction of the first half-housing 3. The locking portion 62 therefore borders the housing 2 in the direction of the main axis 10 of the actuator 1.

The locking portion 62 comprises a finger bar 63 capable of cooperating with the protuberance 52, and in particular with the cavity 57 in the protuberance 52. In particular, the finger bar 63 is capable of being accommodated in the cavity 57. According to this embodiment, the finger bar 63 is arranged on an external face of the locking portion 62.

Advantageously, the finger bar 63 comprises an inclined edge facilitating insertion of the connecting element 53 into the protuberance 52, and a flat region forming a stop locking the position and fastening of the actuator 1 relative to the wall 51 of the heating, ventilation and/or air-conditioning installation 50.

The flexibility of the connecting element53 is obtained by means of a suitable thickness of at least the locking portion 62, measured radially relative to the main axis 10 of the actuator 1. The thickness of the locking portion 62 is, for example, between 0.5 and 2 mm, measured in a radial direction relative to the main axis 10 of the actuator 1.

FIG. 15 shows an alternative embodiment of the second variant of the fastening device according to the present invention. In the present case, cooperation between the connecting element 53 and the protuberance 52 is achieved by causingthe finger bar 63 to abut against an edge 72 arranged at the free end of the protuberance 52.

Production of the edge 72 during a moulding operation of the wall 51 is simplified by the presence of an opening 73 made in the wall 51, directly adjacent to the protuberance 52. It is therefore understood that the opening 73 directly borders the protuberance 52. The opening 73 allows for the passage of a mould insert.

To seal the heating, ventilation and/or air-conditioning installation 50, the housing 2 of the actuator 1 comprises a skirt 74 that seals the opening 73 in the wall 51. Advantageously, the skirt 74 is moulded together with the second half-housing 4 of the actuator 1.

FIGS. 16 to 18 show a third variant of the fastening device in a perspective view, a longitudinal section and a partial top view. FIG. 19 is a section of an alternative to the third variant of the fastening device. The description that will be given of the third variant of the fastening device is limited to the different elements and reference will be made to the description relating to the fastening devices in FIGS. 8 to 15 for like elements.

The wall 51 of the heating, ventilation and/or air-conditioning installation 50 according to the third variant of the fastening device comprises at least one protuberance 52, advantageously two protuberances 52. The protuberance 52 is formed by a curvilinear sector 54, otherwise known as a curve, advantageously moulded together with the wall 51.

According to the third variant, the protuberance 52 is made to be rigid and prevent any deformation when the actuator 1 is joined to the wall 51. In a case like this, the connecting element 53 is formed on the housing 2 of the actuator 1 so as to deform. In this respect, the flexibility of the connecting element 53 is greater than the flexibility of the protuberance 52.

The rigidity of the protuberance 52 is obtained by means of a suitable thickness in particular of the curvilinear sector 54, measured radially relative to the main axis 10 of the actuator 1. The thickness of the protuberance 52 isbetween 2 and 6 mm, measured in a radial direction relative to the main axis 10 of the actuator 1.

The protuberance 52 forms an arm extending perpendicularly to the plane of extension of the wall 51. The free end of the protuberance 52 comprises a holding tooth 67 having the particular feature of extending outwards, that is, in the opposite direction to the actuator 1. In other words, the flat region of the holding tooth 67 gripping the connecting element 53 extends in a plane perpendicular to the main axis 10 of the actuator 1 and the point formed by the holding tooth 67 faces outwards.

The holding tooth 67 may be produced over all or part of the curvilinear sector 54. FIG. 18 shows a variant in which the holding tooth 67 extends over solely a portion of the curvilinear sector 54, in particular at the centre of the curvilinear sector 54.

The connecting element 53 cooperating with the protuberance 52 in this case has a particular structure. The connecting element 53 is a shackle originating from the housing 2 of the actuator 1. According to one embodiment, the connecting element 53 originating from the housing 2 of the actuator 1 comprises a first linking portion 61, which extends radially from the housing 2 of the actuator 1, a locking portion 62, which forms an angle, for example equal to 90°, with the first linking portion 61 and extends angularly around the housing 2 of the actuator 1, and a second linking portion 75, which extends radially from the housing of the actuator 1 and forms an angle, for example equal to 90°, with the locking portion 62.

The connecting element 53 therefore forms a “U” positioned laterally relative to the housing 2 of the actuator 1. The connecting element 53 according to the third variant of the fastening device extends, advantageously, in a plane substantially parallel to the plane of extension of the wall 51.

According to the third variant of the fastening device, the locking portion 62 is rigidly connected to the first linking portion 61 and to the second linking portion 75, while being at a distance from the housing 2 of the actuator 1.

The locking portion 62 follows a curved profile that is substantially similar to the curve followed by the curvilinear sector 54. The flexibility of the connecting element 53 is thus obtained by the curved locking portion 62, which is separate from the housing 2 of the actuator 1. By way of example, the thickness of the locking portion 62 is between 0.5 and 2 mm, measured in a radial direction relative to the main axis 10 of the actuator 1.

The connecting element 53 may be produced on the second half-housing 4, but it is advantageous to arrange it on the first half-housing 3, in such a way as to fasten the actuator 1 to the wall 51 while securing the mechanical connection between the first half-housing 3 and the second half-housing 4.

FIG. 19 shows an alternative embodiment of the third variant of the fastening device according to the presentinvention. Formation of the holding tooth 67 is facilitated by the presence of an opening 73 immediately adjacent to the protuberance 52. It is therefore understood that the opening 73 directly borders the protuberance 52. To seal the heating, ventilation and/or air-conditioning installation 50, the housing 2 of the actuator 1 comprises a skirt 74 that seals the opening 73. Advantageously, the skirt 74 is a continuation, in an axial direction, of the locking portion 62, which extends in a plane parallel to the plane of extension of the wall 51. The connecting element 53 originating from the housing 2 of the actuator 1 having the skirt 74 is arrangedso as to seal the opening 73, which acts as a mould for the holding tooth 67.

It will be noted that fastening of the actuator 1 to the wall 51 of the heating, ventilation and/or air-conditioning installation 50 by means of the fastening device, as described in relation to FIGS. 8 to 10, is brought about by a rotational movement of the actuator 1 about the main axis 10, passing through the axis of the component 70 to be controlled, in particular a flap.

In the variants described in relation to FIGS. 11 to 19, fastening of the actuator 1 to the wall 51 of the heating, ventilation and/or air-conditioning installation 50 by means of the fastening device is brought about by a translationalmovement of the actuator 1 parallel to the main axis 10. The actuator 1 is therefore inserted in the direction of the component to be controlled.

In the two cases above, the actuator 1 is finally rigidly connected to the wall 51 without the use of screws.

FIGS. 20 to 22 show particular configurations of the protuberance 52 and of the connecting element 53 in, respectively, on the one hand, a section of a detail and a partial top view of a fourth variant of the fastening device and, on the other hand, asection of a detail of a fifth variant of the fastening device.

In these embodiments, the protuberance 52 is formed by a curvilinear or flat sector originating from the wall 51 of the heating, ventilation and/or air-conditioning installation 50. The holding tooth 67 oriented in the direction of the actuator 1 is arranged at the end of the curvilinear or flat sector originating from the wall 51.

In FIG. 20, the connecting element 53 originating from the housing 2 of the actuator 1 is formed by a first linking portion 61, a second linking portion 75 and a locking portion 62 arranged between the first linking portion 61 and the second linking portion 75. What is particular is thatthe locking portion 62 is also connected to the housing 2 of the actuator 1.

The connecting element 53 thus forms a plate of which the free edge follows a curvilinear profile. In a case like this, the flexibility required for assembly is obtained by the protuberance 52, which is more flexible than the connecting element 53. It will also be noted that the skirt 74 sealing the opening 73 starts in this case at the housing 2 of the actuator 1, in particular at the second half-housing 4.

FIG. 21 shows the curvilinear shape of the connecting element 53, as well as the presence of the holding tooth 67 formed at the free end of the protuberance 52 overlapping the connection of the connecting element 53.

FIG. 22 also shows a connecting element 53 and a protuberance 52, each having a curved profile. What is particular is that the skirt 74 is formed at the free end of the locking portion 62 of the connecting element 53. The skirt 74 forms an “L” in this case, in such a way as to seal the opening 73 made in the wall 51 to allow moulding of the holding tooth 67 at the free end of the protuberance 52.

FIGS. 23 to 28 show an electrical connector 100 suitable for rigidly connecting the actuator 1 to a wall 51 of a heating, ventilation and/or air-conditioning installation 50.

In the case where a unit is formed by the electrical connector 100 and an actuator 1 according to the present invention, the electrical connector 100 comprises, in general, a housing 2 accommodating at least one electric motor 13 which drives, for example by means of a speed reducer 15, an output stub 24 intended to set in motion a component 70, mounted inside a heating, ventilation and/or air-conditioning installation 50.

More precisely, the actuator 1 comprises the housing 2 accommodating at least one electric motor 13, which drives a drive shaft 14 extending along a first axis 16, a speed reducer 15, driven by the drive shaft 14 and setting in motion an output stub 24 intended to drive a component 70. Preferably, the speed reducer 15 extends along a second axis 17 and the output stub 24 extends along a third axis 26. Advantageously, the electric motor 13, the speed reducer 15 and the output stub 24 are arrangedinside the actuator 1 so that the first axis 15, the second axis 17 and the third axis 26 are coincident, thus forming the main axis 10 of the actuator 1.

In a case like this, the actuator 1 may comprise one or more of the features presented in detail with reference to the embodiment described in relation to FIGS. 1 to 7.

The electrical connector 100 is intended to electrically connect a cable 122 to the actuator 1 of a heating, ventilation and/or air-conditioning installation 50. It is formed to provide electrical signals on the one hand and to rigidly connect the actuator 1 to the wall 51 of the heating, ventilation and/or air-conditioning installation 50 on the other hand.

FIGS. 23 and 24 are perspective views of, respectively, a first side and a second side of the electrical connector 100 according to the present invention.

The electrical connector 100 comprises a first connection portion 101, capable of accommodating an end of the cable 122, and a second connection portion 102, capable of locking the actuator 1 in a position relative to the wall 51, in particular of the heating, ventilation and/or air-conditioning installation 50.

The first connection portion 101 and the second connection portion 102 are separate but mechanically interconnected by a connecting body 103, forming an intermediate portion arranged between the first connection portion 101 and the second connection portion 102.

The electrical connector 100 comprises a recess 104 defined by the first connection portion 101, the second connection portion 102 and the connecting body 103.

The recess 104 thus forms a channel intended to receive a portion of the wall 51 of the heating, ventilation and/or air-conditioning installation 50 and a portion of the actuator 1.

The first connection portion 101 comprises a reception device 105, intended in particular to receive the end of the cable 122, and a slider 106, intended for insertion into the actuator 1. In addition, the slider 106 is also used for guidance during placing of the electrical connector 100 on the actuator 1.

The receiving means 105 is a cavity formed in the first connection portion 101. The receiving means 105 have, on one side of the first connection portion 101, a connecting pin 107, by means of which the cable 122 is connectable to the first connection portion 101, and, on the opposite side to the connecting pin 107, a plurality of holes 108, by means of which terminals of an electrical plug 11 of the actuator 1 are connected to the electrical connector 100. It will be noted that the receiving means 105 is arranged so as to receive male and/or female connectors arranged at the end of a cable 122, in particular of the multistrand type.

The slider 106 has a U-shaped cross section. In addition, the slider 106 comprises at least one lateral groove 109, preferably two lateral grooves 109 and 110. The U-shaped cross section and the lateral grooves 109 and 110 guide the electrical connector 100 during insertion into the actuator 1. In this respect, the actuator 1 thus comprises complementary channels capable of cooperating with the U-shaped cross section and/or the lateral grooves 109 and 110.

The slider 106 also comprises at least one stop 111 for stopping the translation of the electrical connector 100 in the actuator 1. Locking of the electrical connector 100 to the actuator 1 is brought about by a locking means 112 arranged on a flexible tongue 113 extending inside the slider 106. The flexible tongue 113 can be actuated with a view to unlocking the locking means 112 and extracting the electrical connector 100 from the actuator 1. According to one embodiment, the locking means is a notch extending from the flexible tongue 113.

The slider 106 also comprises a gripping region 114 facilitating handling of the electrical connector 100 during insertion or extraction with respect to the actuator 1.

Preferably, the connecting body 103 is recessed at its centre or hollow. Similarly, the second connection portion 102 isrecessed at its centre or hollow.

The second connection portion 102 has a particular shape: the second connection portion 102 has a conical cross section, in the direction of insertion of the electrical connector 100. In other words, the second connection portion 102 forms a prism of which the end on the side of the plurality of holes 108 is smaller than the end on the side of the connecting pin 107. The prism shape of the second connection portion 102, as previously presented in detail, defines the profile in conicalcross section of the second connection portion 102.

Advantageously, the second connection portion 102 is deformable. Such a deformation occurs at the time of insertion of the electrical connector 100 in such a way that the second connection portion 102 exerts a load on the wall 51 of the heating, ventilation and/or air-conditioning installation 50, with a view to ensuring an air-tight seal.

The connecting body 103 may also be flexible; this facilitates the insertion operation and compensates for dimensional tolerances in the joint between the actuator 1 and the wall 51 of the heating, ventilation and/or air-conditioning installation 50.

FIG. 25 is a perspective view of the wall 51 of the heating, ventilation and/or air-conditioning installation 50, capable of receiving the electrical connector 100, and shows the wall 51 of the heating, ventilation and/or air-conditioning installation 50 to which the actuator 1 is rigidly connected by the electrical connector 100 according to the present invention.

The wall 51 comprises at least one centring pin 71, preferably two centring pins 71, on which the actuator 1 is mounted. The wall 51 also comprises a passage 58 through which the output stub 24 of the actuator 1 passes.

The wall 51 also has a connecting appendage 115 through which the second connection portion 102 of the electrical connector 100 can be inserted. According to a variant that is not shown, the connecting appendage 115 can be made in the plane of extension of the wall 51.

According to the variant shown in FIG. 25, the wall 51 comprises a projection 116, preferably in the shape of an arch 116, which extends from the plane of extension of the wall 51. The projection 116 thus forms a bulge in the wall 51, having an overall shape complementary to the shape of the second connection portion 102. In a case like this, the connecting appendage 115 has an opening made in one of the faces of the projection 116 and extending, preferably, in a plane substantially perpendicular to the plane of the wall 51.

FIG. 26 is a cross section of the actuator 1, which is rigidly connected to the wall 51 of the heating, ventilation and/or air-conditioning installation 50 by means of the electrical connector 100 according to the present invention. It is a cross section through the first connection portion 101 and the second connection portion 102 of the electrical connector 100.

The heating, ventilation and/or air-conditioning installation 50 is equipped with the actuator 1 and the electrical connector 100 according to the present invention 100.

According to this embodiment, the electrical connector 100 is accommodated inside the actuator 1. More particularly the electrical connector 100 is received in the electrical plug 11, which may be identical to that described in relation to FIGS. 1 to 7 for example.

The first connection portion 101 in this case forms a male element inserted in the electrical plug 11, thus forming a female element. Nevertheless, it is also possible for the first connection portion 101 to form a female element in which the electrical plug 11 is accommodated, thus forming a male element.

The second connection portion 102 is inserted in the projection 116. It can be seen here that the wall 51 of the heating, ventilation and/or air-conditioning installation 50 and an external wall 117 of the actuator 1, or of the electrical plug 11 of the actuator 1, are arranged in the recess 104 of the electrical connector 100.

The wall 51 of the heating, ventilation and/or air-conditioning installation 50 and the external wall 117 of the actuator 1, or of the electrical plug 11 of the actuator 1, are therefore sandwiched between the first connection portion 101 and the second connection portion 102 of the electrical connector 100.

The actuator 1 is thus blocked in translation so as to be inseparable from the wall 51 in a direction corresponding to the main axis 10 of the actuator 1.

Additionally, the actuator 1 is blocked in rotation relative to the wall 51, since the first connection portion 101 bears laterally against the lower edges 118 and 119 of the actuator 1, or of the electrical plug 11 of the actuator 1, whereas the second connection portion 102 is in contact with lateral edges 120 and 121 defining the projection 116.

FIG. 17 is a perspective view of the actuator 1 connected to the wall 51 by means of the electrical connector 100 according to the present invention. Thus fitted, the actuator 1 and the electrical connector 100 connected to a cable 122 are arranged on the heating, ventilation and/or air-conditioning installation 50.

FIG. 27 shows an alternative embodiment of the actuator 1, which differs from the variant described with reference to FIGS. 1 to 7. Indeed, the electric motor 13 of the actuator 1 is arranged laterally relative to the speed reducer 15. Put differently, the first axis 16 of the electric motor 13 is parallel to but separate from the second axis 17 of the speed reducer 15. Despite this difference in the structure of the actuator 1, said actuator is nevertheless rigidly connected, at least in translation, to the wall 51 of the heating, ventilation and/or air-conditioning installation 50 by the electrical connector 100 according to the present invention.

FIG. 28 is a longitudinal section of the wall 51 and of the actuator 1 showing in detail the cooperation of the first connection portion 101 with the actuator 1, and the cooperation of the second connection portion 102 with the wall 51 of the heating, ventilation and/or air-conditioning installation 50. FIG. 28 is a longitudinal section parallel to the direction of insertion or extraction of the electrical connector 100 in the actuator 1.

According to a particular embodiment, at least one lateral face 123 defining the connecting appendage 115 is bevelled in an orientation complementary to the conical shape of the second connection portion 102.

Because of the airflow inside the heating, ventilation and/or air-conditioning installation 50, it is advantageous to ensure an air-tight seal perpendicular to the connecting appendage 115. The invention therefore provides that the second connection portion 102 encloses the connecting appendage 115 in an air-tight manner. This is achieved for example by peripheral contact between the second connection portion 102 and the lateral face 123 defining the connecting appendage 115.

Alternatively or additionally, this same object is achieved by the fact that the second connection portion 102 is deformable so as to match the shape of the lateral face 123 of the projection 116.

It will be noted that the electrical connector 100 comprising the first connection portion 101 and the second connection portion 102 is advantageously a unit. It thus formsasingle part produced in a single moulding step.

Finally, it will be noted that the locking in translation of the electrical connector 100 can be brought about solely by the locking means 112 coming to bear on the actuator 1. The locking means 112 alone thus performs a function of holding the electrical connector 100 in the actuator 1, and simultaneously a function of rigidly connecting the actuator 1 to the wall 51.

Alternatively or additionally, the locking means 112 can be arranged between the electrical connector 100 and the wall 51 of the heating, ventilation and/or air-conditioning installation 50. In a case like this, the locking means 112 is arranged on the second connection portion 102 of the electrical connector 100. It is thus a locking finger arranged on the second connection portion 102 and capable of blocking translation of the electrical connector 1 relative to the heating, ventilation and/or air-conditioning installation 50 by means of the wall 51. Thus arranged, the locking means 112 performs the function of holding the electrical connector 100 relative to the wall 51 of the heating, ventilation and/or air-conditioning installation 50, and simultaneously a function of rigidly connecting the electrical connector 100 in the actuator 1.

Of course, the invention is not limited to the previously described embodiments provided solely by way of example. It encompasses various modifications, alternative forms and other variants that a person skilled in the art may envisage within the scope of the present invention and in particular all combinations of the various previously described modes of operation, which can be taken separately or in combination.

1. An electric actuator (1) capable of driving a component (70) of a ventilation, heating and/or air-conditioning installation (50) of a vehicle, the electric actuator (1) comprising:
a housing (2) accommodating at least one electric motor (13), which drives a drive shaft (14) extending along a first axis (16), a speed reducer (15) driven by the drive shaft (14) and setting in motion an output stub (24) intended to drive the component (70);
wherein the speed reducer (15) extends along a second axis (17) and the output stub (24) extends along a third axis (26); and
wherein the first axis (16), the second axis (17) and the third axis (26) are coincident, thus forming a main axis (10) of the electric actuator (1).

2. An electric actuator (1) according to claim 1, wherein the electric motor (13), the speed reducer (15) and the output stub (24) are stacked in this order along the main axis (10).

3. An electric actuator (1) according to claim 1, wherein the output stub (24) comprises a hub (12) for driving the component (70) which extends along the third axis (26).

4. An electric actuator (1) according to claim 3, wherein the drive hub (12) is a continuation of the stack formed by the electric motor (13), the speed reducer (15) and the output stub (24).

5. An electric actuator (1) according to claim 4, wherein the housing (2) is formed by assembling a first half-housing (3) and a second half-housing (4).

6. An electric actuator (1) according to claim 5, wherein a means (23) is provided for aligning the electric motor (13) relative to the speed reducer (15).

7. An electric actuator (1) according to claim 6, wherein the alignment means (23) comprises a base (34) inserted between the electric motor (13) and the speed reducer (15), with the base (34) comprising a first lateral face (35) and a second lateral face (36) which are arranged so as to ensure alignment of the electric motor (13) and the speed reducer (15).

8. An electric actuator (1) according to claim 6, wherein the alignment means (23) comprises at least one protrusion (37) interposed between the first half-housing (3) and the second half-housing (4).

9. An electric actuator (1) according to claim 1, wherein the speed reducer (15) comprises at least one support (20) on which at least two sun gears (21, 22) rest, which drive a ring gear (19) connected to the output stub (24).

10. An electric actuator (1) according to claim 1, wherein a printed circuit (27) is installed in the housing (2) in a plane of extension parallel to the main axis (10).

11. An electric actuator (1) according to claim 10, wherein an electrical plug (11) is provided that is rigidly connected to the printed circuit (27) and mechanically connected to the housing (2).

12. An electric actuator (1) according to claim 11, wherein the electrical plug (11) comprises at least one electrical terminal (31) that is rigidly connected to the printed circuit (27) and extends preferably in a direction perpendicular to the main axis (10).

13. A ventilation, heating and/or air-conditioning installation (50) comprising at least one component (70) driven by an electric actuator (1) according to claim 1.

14. A ventilation, heating and/or air-conditioning installation (50) according to claim 13, comprising a wall (51) which defines an internal volume of the ventilation, heating and/or air-conditioning installation (50) with respect to a surrounding area, the component (70) being a flap installed in the internal volume and the electric actuator (1) being fastened to the wall (51) in the surrounding area.

15. An electric actuator (1) according to claim 2, wherein the output stub (24) comprises a hub (12) for driving the component (70) which extends along the third axis (26).

16. An electric actuator (1) according to claim 2, wherein the speed reducer (15) comprises at least one support (20) on which at least two sun gears (21, 22) rest, which drive a ring gear (19) connected to the output stub (24).
